(19) United States
(12) Patent Application Publication
(10) Pub. No.: US 2008/0105857 A1
(43) Pub. Date: May 8, 2008

(54) Flame-Retardant System Based on Phosphorus Compounds and Flame-Retarded Polymer Composition

(76) Inventors: Xavier Couillens, Tournefeuille (FR); Lorraine Leite, Bruxelles (BE); Jean-Emile Zanetto, Paris (FR)

Correspondence Address: Jean-Louis Seugnet;Rhodia, 8 Cedar Brook Drive, CN 7500, Cranbury, NJ, 08512-7500, US

(21) Appl. No.: 10/583,170

(22) PCT Filed: Dec. 17, 2004
(86) PCT No.: PCT/FR04/03280

§ 371 Date: Nov. 2, 2007

(30) Foreign Application Priority Data
Dec. 19, 2003 (FR) 0314993

(51) Int. Cl. C08K 5/49

(52) U.S. Cl. 252/609

(57) ABSTRACT

The present invention relates to a flame-retardant system for polymers and to polymer-based flame-retarded compositions.

It relates more particularly to a flame-retardant system comprising phosphorus-comprising compounds as flame-retardant agent. The invention provides a flame-retardant system, in particular for polymers and polymer-based compositions. This flame-retardant system comprises, as flame-retardant agent, at least one compound belonging to the family of the esters and salts of phosphoric, phosphinic and phosphonic acids and at least one other compound which stabilizes the flame-retardant agent.

The present invention relates to a flame-retardant system for polymers and to polymer-based flame-retarded compositions.

It relates more particularly to a flame-retardant system comprising phosphorus-comprising compounds as flame-retardant agent.

In some fields, such as that of the manufacture of textile surfaces, these surfaces are rendered flame-retarded by a treatment with liquid or soluble flame-retardant compounds which consist in depositing the said compounds over the surface of the textile or of the fibres and yarns constituting it.

In these applications, use is often made of phosphorus-based liquid flame-retardant agents and in particular of the esters and salts of phosphoric, phosphinic or phosphonic acids.

These treatments are generally carried out at temperatures of less than 200° C.

These flame-retardant agents can also be used to render various materials flame-retarded. In some of these applications, it is necessary to bring the flame-retardant agent to high temperatures, in particular of greater than 200° C., for example, in order to mix them with the polymer. However, to heat in this way at a temperature of greater than 200° C. brings about modifications to the flame-retardant agent which may be disadvantageous to the properties of the polymer. Thus, the modifications to the flame-retardant agents may bring about the formation of coloured compounds, which affect the appearance of the polymer, or compounds which can react with other products present in the polymer or the composition comprising the said polymer.

One of the aims of the present invention is in particular to overcome these disadvantages by providing a novel flame-retardant system based in particular on flame-retardant agents mentioned above which no longer produces by-products or prodegradative products when it is brought to temperatures of greater than 200° C.

To this end, the invention provides a flame-retardant system in particular for polymers and polymer-based compositions. This flame-retardant system comprises, as flame-retardant agent, at least one compound belonging to the family of the esters and salts of phosphoric, phosphinic and phosphonic acids and at least one other compound which stabilizes the flame-retardant agent.

This stabilization can be obtained, for example, by complete or partial neutralization of the acid functional groups present in the flame-retardant agent.

This is because the esters and salts of phosphoric, phosphinic and phosphonic acids are obtained by processes resulting in products comprising free acidity.

Thus, the compounds, such as the phosphoric compounds, for example, can comprise a high amount of free acid which is evaluated by potentiometric assaying and expressed in mg of KOH per mg of product. Thus, these compounds can comprise up to 10 mg of KOH per mg of product.

According to one characteristic of the invention, the stabilizing compound advantageously exhibits a basic nature which allows it to neutralize or block the acidity present in the flame-retardant agent. This stabilizing compound must also be able to be employed at high temperatures, in particular of greater than 200° C. This is because this stabilizing compound is added to the polymers or compositions when the latter are molten or at least will be brought to the melting point of these materials and to their forming temperature.

According to the invention, the stabilizing compounds suitable for the invention are chosen from the group consisting of alkali metal and alkaline earth metal carbonates, hydrotalcites, aluminosilicates, more generally inorganic compounds possessing a basic nature which can be dispersed in the form of particles with a size of less than 1 mm in a polymer.

According to the invention, the presence in the flame-retarded polymer or composition of the flame-retardant agent and of the compound., referred to hereinafter as stabilizing agent for greater clarity, makes it possible to reduce, indeed even to eliminate, the disadvantages arising from the instability of the flame-retardant agents at the temperatures at which the compositions are formed.

Mention is also made, as stabilizing agent suitable for the invention, of melamine condensation compounds, such as melem, melam, melon, their mixtures, melamine derivatives, such as melamine cyanurate, phosphates and polyphosphates, or the mixtures of these compounds with one another or with melamine. These additives have in particular a stabilizing effect by a mechanism which may be the same as or different from that described above.

The various stabilizing additives described above may also have other effects on the properties of the composition comprising them. Thus, the flame-retardant properties introduced by the phosphorus compound may be improved. Likewise, some mechanical and physicochemical properties may be modified.

According to one characteristic of the invention, the ratio by weight of the stabilizing compound to the phosphorus-comprising flame-retardant agent is between 30% and 80%.

According to the invention, the two compounds, flame-retardant agent and stabilizing agent, can be premixed before they are introduced into the polymer to be rendered flame-retardant.

It is also possible to add the two compounds separately to the polymer to be rendered flame-retardant.

However, in this embodiment, the stabilizing compound will advantageously be added before the phosphorus-comprising flame-retardant compound.

According to a preferred embodiment of the invention, the phosphorus-comprising compound or flame-retardant agent is impregnated on a porous solid support. In this case, the ratio by weight indicated above is determined between the weight of stabilizing agent and the weight of phosphorus-comprising compounds impregnated on the porous support.

In this embodiment, it is possible also to impregnate the stabilizing compound on the porous support, either simultaneously with the phosphorus-comprising compound or according to successive impregnation stages.

The term “impregnation” is understood to mean that the flame-retardant compound is bonded at least temporarily to the solid substrate by any type of bond, such as absorption in the porous structure of the particle, if this structure exists, wetting or adsorption of the flame-retardant compound at the surface of the particles by at least one layer of the flame-retardant compound, or fixing or grafting of the flame-retardant compound to the surface of the particles by chemical or physicochemical bonds.

Thus, such adsorption or fixation is facilitated by the choice of a solid substrate exhibiting surface properties compatible with the properties of the flame-retardant compound. For example, a substrate possessing a hydrophilic surface property is advantageously combined with a flame-retardant compound possessing a hydrophilic nature, and conversely for the compounds possessing a hydrophobic nature.

Furthermore, the particle of the solid substrate can advantageously comprise elements or radicals which promote the adsorption of the flame-retardant compound at the surface of the said particle.

The term “solid substrate” or “porous support” is understood to mean preferably an inorganic substrate which is solid at the temperature for conversion of the polymers and more particularly an inorganic oxide.

The inorganic oxide can be chosen from silica, alumina, silica/alumina, sodium silicoaluminate, calcium silicate, magnesium silicate, zirconia, magnesium oxide, calcium oxide, cerium oxide or titanium oxide. The inorganic oxide can be completely or partially hydroxylated or carbonated.

Among these substrates, those which can be dispersed in the thermoplastic in the form of small particles or aggregates, advantageously in order to obtain dispersed particles exhibiting a diameter or size of less than 5 μm, and more advantageously still for at least 80% by number of the dispersed particles to exhibit a diameter or size of less than 1 μm.

Such a dispersion can be obtained by mixing particles already exhibiting such size characteristics into the polymer or more advantageously by using granules or agglomerates of substrates formed by the agglomeration of particles or aggregates where at least 80% by number of the particles or aggregates exhibit a diameter or a size of less than 1 μm. These granules or agglomerates, after addition to the polymer and under the action of shear forces applied in order to produce the dispersion, break up to give individual aggregates or particles, thus making it possible to obtain a very good dispersion of the flame-retardant agent in the polymer.

In the latter embodiment, the agglomerates or granules preferably exhibit a high specific surface and a high porosity between the individual aggregates or particles in order to allow the flame-retardant compound to be adsorbed at least at the surface of the aggregates or particles. The aggregates or particles can also exhibit a porosity which allows the flame-retardant compound or agent to be absorbed.

In this embodiment, the mean diameter or size of the granules or agglomerates is not critical and is advantageously chosen in order to be able to easily handle the composition possessing flame-retardant properties, in particular during its addition to the polymer. In addition, the mean diameter or size of these granules is also chosen in order to facilitate the addition and the adsorption of the flame-retardant compound, for example in order to prevent sticking between the different granules. For this reason, the flame-retardant compound can be added in the form of a powder exhibiting good flowability and without generating dust.

By way of indication, granules with a mean diameter D50 of greater than 60 μm, advantageously of between 80 μm and 300 μm, are preferred.

Among the inorganic substrates mentioned above, some silicas exhibit these characteristics and are thus particularly preferred.

Thus, some silicas exhibiting the property of dispersing in the form of particles or aggregates with a diameter or size of between 0.05 μm and 1 μm will be preferred in implementing the present invention.

In addition, the inorganic substrates which are particularly suitable for the invention are those, the granules or agglomerates of which exhibit a high porosity and a high specific surface. Thus, the preferred substrates are those having granules exhibiting a total pore volume of at least 0.5 ml/g, preferably of at least 2 ml/g. This pore volume is measured by the mercury porosimetry method with a Micromeritics Autopore III 9420 porosimeter, according to the following procedure:

The sample is dried beforehand in an oven at 200° C. for 2 hours. The measurements are subsequently carried out according to the procedure described in the handbook supplied by the manufacturer.

The pore diameters or sizes are calculated by the Washburn relationship with a contact angle theta equal to 140° and a surface tension gamma equal to 485 dynes/cm.

Advantageously, the inorganic substrates or porous supports exhibiting a pore volume of at least 0.50 ml/g for the pores having a diameter or size of equal to or less than 1 μm are preferred.

According to a preferred embodiment of the invention, the inorganic substrate is a silica, advantageously an amorphous silica. The silicas are obtained by various processes, including two main processes resulting in silicas referred to as precipitated silica and fumed silica. The silica can also be prepared in the gel form.

The silicas exhibiting a specific surface, measured according to the CTAB method, of greater than 50 m²/g are preferred.

Precipitated silicas are preferred as they can be provided in the form of agglomerated particles forming granules with a size from at least 50 μm or greater to 150 μm.

They can be provided in the form of substantially spherical beads or granules obtained, for example, by atomization, as described in European Patent No. 0 018 866. This silica is sold under the generic name of Microperle. Such silicas, which exhibit noteworthy properties of flowability and of dispersability and a high impregnation capacity, are described in particular in European Patents 966 207, 984 772 and 520 862 and International Applications WO 95/09127 and WO 95/09128.

Other types of silicas may be suitable for the invention, such as those described in French Patent Application No. 01/16881, which are pyrogenic silicas or silicas partially dehydroxylated by calcination or surface treatment.

These examples of silicas used as solid inorganic substrate are described only by way of indication and as preferred embodiments. Use may also be made of other silicas obtained by other processes exhibiting porosity and dispersability properties suitable for carrying out the invention.

According to the invention, the flame-retardant additive comprises a flame-retardant compound adsorbed on the particles of inorganic substrate. In a preferred embodiment of the invention, this adsorption is obtained by impregnation of the granules or agglomerates. This impregnation is carried out by any conventional means, for example by mixing the substrate with the flame-retardant compound in the liquid state or in the form dispersed or dissolved in a solvent. In the latter case, after impregnation of the substrate, the solvent will be removed by evaporation.

The term “a flame-retardant compound or agent” should be understood as meaning one or more flame-retardant compounds or a mixture of compounds forming a system exhibiting flame-retardant properties.

The inorganic oxide is preferably precipitated silica. It can, for example, be a silica sold under the trade names Tixosil 38A, Tixosil 38D or Tixosil 365 from Rhodia.

The precipitated silica can be a highly dispersible silica, such as the silicas described in the documents EP 520 862, WO 95/09127 or WO 95/09128, which facilitates the dispersion thereof in the polymer and has a positive effect on the mechanical properties of the material obtained. It can, for example, be a silica sold under the trade names Z1165 MP or Z1115 MP from Rhodia.

In particular, the precipitated silica can be provided in the form of substantially spherical beads, in particular with a mean size of at least 80 microns, for example of at least 150 microns, obtained using a nozzle atomizer, as described, for example, in the document EP 0 018 866. It can, for example, be Microperle silica. This form makes it possible to optimize the impregnation capacity and the flowability of the powder, as is described, for example, in the documents EP 966 207 or EP 984 772. It can, for example, be a Tixosil 38X or Tixosil 68 silica from Rhodia.

In this embodiment and depending on the nature of the stabilizing agent, the latter can be mixed with the solid particles on which the flame-retardant agent is impregnated. It is also possible to co-impregnate the flame-retardant agent and the stabilizing agent on the porous solid particles.

The phosphorus-comprising compound or flame-retardant agent is advantageously an agent which is liquid at ambient temperature (approximately 25° C.). This liquid agent can be chosen from any liquid flame-retardant agent known to a person skilled in the art, with the exception of orthophosphoric acid or polyphosphoric acid.

Mention may in particular be made of phosphorus-based liquid flame-retardant agents, such as phosphonic acids, their esters and salts, phosphoric esters or phosphinic acids, their esters and salts.

Use may in particular be made of liquid flame-retardant agents which are viscous, which adhere and/or which are difficult to handle or clean.

The term “viscous liquid” is understood to mean any liquid which has a viscosity of greater than 100 centipoises at a temperature of 25° C., preferably more than 1000 centipoises at a temperature of 25° C. and more preferably still more than 10,000 centipoises at a temperature of 25° C., this viscosity being measured via a device of Brookfield type with a spindle and a rotational speed suited to the viscosity measured. For example, a cylindrical spindle and a rotational speed of 50 rev/min are used in the case where the viscosity is in the region of 100 centipoises.

Mention may be made, as flame-retardant compounds suitable for the invention, by way of example, of the bis[(5-ethyl-2-methyl-2-oxido-1,3,2-dioxaphosphorinan-5-yl)methyl] ester of methylphosphonic acid of following formula:

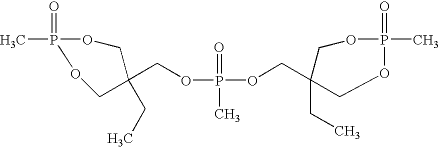

alone or as a mixture with the methyl and (5-ethyl-2-methyl-2-oxido-1,3,2-dioxaphosphorinan-5-yl)methyl ester of methylphosphonic acid of following formula:

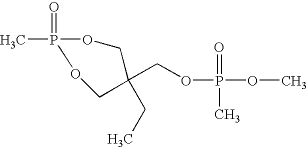

resorcinol bis(diphenyl phosphate), bisphenol A bis(diphenyl phosphate), polyphosphate esters, diethylphosphinic acid, ethylmethylphosphinic acid, methyl(n-propyl)phosphinic acid, and their mixtures, esters and salts.

Mention may be made, by way of illustration, of viscous liquids sold under the trade names Amgard 1045 (mixture of methylbis((5-ethyl-2-methyl-1,3,2-dioxaphosphorinan)phosphonic acid and of methyl(5-ethyl-2-methyl-2-oxido-1,3,2-dioxaphospho)phosphonic acid) sold by Rhodia, the viscosity of which shown on the marketing sheets is 500,000 centipoises at 25° C. and 1000 centipoises at 110° C.); Fyrolflex RDP (resorcinol bis(diphenyl phosphate)) sold by Akzo, the viscosity of which shown on the marketing sheets is 600 centipoises at 25° C., and Fyrolflex BDP (bisphenol A bis(diphenyl phosphate)) sold by Akzo, the viscosity of which shown on the marketing sheets is 12,450 centipoises at 25° C.

Mention may also be made, by way of illustration, of the compounds or compositions sold by Rhodia under the trade name Amgard CU or Amgard CT, the viscosity of which shown on the marketing sheets is 500,000 centipoises at 25° C. and 1000 centipoises at 110° C. and which comprise products present in Amgard 1045 in different proportions, or the diphenyl phosphate ester derivatives sold by Akzo under the name Fyrolflex, the viscosity of which shown on the marketing sheets is 12,450 centipoises at 25° C., or Great Lakes Chemical Corp. under the name Rheophos DP. Finally, Daihachi Chemical Industry sells polyphosphate esters under the names CR 741, CR 733 and CR741S.

As indicated above, these compounds can be impregnated directly on the substrate, such as a silica, for example, or dissolved in a solvent, such as, for example, water, organic solvents, such as ketones, alcohols, ethers, hydrocarbons, halogenated solvents, for example.

Another subject-matter of the present invention is the use of the flame-retardant system described above for rendering various polymers flame-retardant, in particular polymers such as thermoplastic polymers, thermosetting polymers or elastomers.

When the polymer or the copolymer is thermoplastic, it can be a polymer chosen from polyamides, polycarbonates, polyesters, styrene polymers, acrylic polymers, polyolefins, poly(vinyl chloride)s and their derivatives, poly(phenylene ether)s, polyurethanes or their blends.

When the polymer is a thermoplastic or thermosetting polyamide, it is chosen from the group consisting of the polyamides obtained by polycondensation of a linear dicarboxylic acid with a linear or cyclic diamine, such as PA 6.6, PA 6.10, PA 6.12, PA 12.12, PA 4.6 or MXD 6, or between an aromatic dicarboxylic acid and a linear or aromatic diamine, such as polyterephthalamides, polyisophthalamides or polyaramides, and the polyamides obtained by polycondensation of an amino acid with itself, it being possible for the amino acid to be generated by the hydrolytic opening of a lactam ring, such as, for example, PA 6, PA 7, PA 11 or PA 12. Use may also be made of copolyamides derived in particular from the above polyamides, or the blends of these polyamides or copolyamides.

Use may also be made of branched polyamides or star polyamides.

The preferred polyamides are poly(hexamethylene adipamide), polycaprolactam or the copolymers and blends between poly(hexamethylene adipamide) and polycaprolactam.

When the polymer is a polyester, it can, for example, be poly(butylene terephthalate), poly(propylene terephthalate) or poly(ethylene terephthalate), or their blends.

When the polymer is a styrene polymer, it can, for example, be polystyrene, styrene/butadiene (SB), polystyrene/acrylonitrile (SAN), acrylonitrile/butadiene/styrene (ABS), or their copolymers or their blends.

When the polymer or the copolymer is a polyolefin, it can be chosen, for example, from polypropylene, polyethylene, ethylene/vinyl acetate (EVA) copolymer or their blends.

When the polymer is thermosetting, it can be a polymer chosen from polyurethane, epoxy resins (such as Araldite), polyester resins, phenolic resins (such as Bakelite) or aminoplasts (such as Formica).

When the flame-retardant composition of the invention is added to thermoplastic polymers (including thermoplastic elastomers), it is incorporated by blending, preferably in a single-screw or twin-screw extruder. The blend is extruded in the form of articles, such as profiles, or more advantageously in the form of laces which will be cut into granules. The granules are used as starting material in processes for producing articles and will be melted in order to feed the flame-retarded composition to forming processes, such as injection moulding, extrusion, extrusion blow-moulding or the like processes.

The blend can also comprise one or more additives normally used in this field.

The total amount of flame-retardant agent, expressed as weight of phosphorus, in the composition varies from 1 to 20%, preferably from 5 to 15%, with respect to the total weight of the blend obtained.

When the inorganic oxide impregnated with liquid flame-retardant agent is incorporated in thermosetting polymers, the inorganic oxide impregnated with liquid flame-retardant agent and the other additives are advantageously incorporated in one of the monomers or oligomers before the polymerization or crosslinking reaction. The amounts of inorganic oxide impregnated with liquid flame-retardant agent used are within the same proportions as those described for the thermoplastic polymers.

In addition, it is possible to add any additive generally used for the manufacture of compositions where the compositions are used, for example, for the manufacture of moulded articles, in particular in the electrical field.

Mention may be made, by way of examples, of reinforcing or bulking fillers, additives for heat or light stabilization, additives for improving impact strength, pigments or dyes. This list has no limiting nature.

Other details and advantages of the invention will become more clearly apparent in the light of the examples, which are given below purely by way of indication and with reference to the single appended FIGURE, which represents a photograph of the bottles used for the stabilization test.

### EXAMPLES 1 to 4

50 g of flame-retardant compounds sold under the trade name Amgard 1045 are mixed with 1% by weight of stabilizing additive. The mixture is brought to 200° C. under reflux and with stirring, at atmospheric pressure, for 30 minutes.

After cooling, the final colour of the mixture makes it possible to determine the stabilizing effect of the additive.

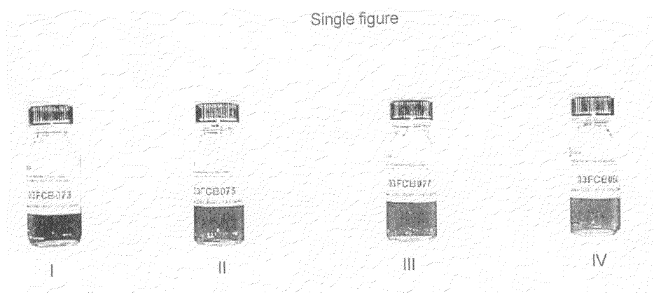

The tests carried out are collated in Table I below. The colour of the mixtures obtained after heat treatment is illustrated in FIG. 1, which is a photograph of the bottles obtained in the tests carried out.

Test

| | 1 | 2 | 3 | 4 |
|---|---|---|---|---|
| Stabilizing | — | Na₂CO₃ | MgO | Hydrotalcite (i) |
| additive | | | | |
| Bottle | I | II | III | IV |

(i) hydrotalcite sold by Sud Chemie under the name EXM 696.

These results obtained clearly show the stabilizing effect of the additives tested.

### EXAMPLE 5 to 7

Compositions based on polyamide 6.6 comprising 30% by weight of glass fibres were prepared.

These compositions comprise variable amounts of flame-retardant agent and of stabilizing agent.

Preparation of a Flame-Retardant Agent Impregnated on a Silica Support

The silica of high porosity used is a silica known as Tixosil 38X from Rhodia having a total pore volume of 4.2 ml/g and a working volume of 2.2 ml/g.

The amount of Amgard concentrate used for the impregnation corresponds to the maximum amount which it is possible to impregnate on the silica, that is to say the volume for which saturation of the silica is obtained.

Impregnation takes place under dry conditions. The Amgard 1045, preheated to 80° C. in order to render it more fluid, is added by 25 ml dropwise.

25 grams of silica are weighed. The maximum impregnated volume achieved is 50 ml of Amgard 1045, i.e. 63 g.

The final product is thus composed of 55% by weight of Amgard 1045 and of 45% of silica.

It is provided in the form of a powder for which the diameter (D50) of the particle size distribution is 250 μm. D50, in the field of powder particle sizing, is the diameter or size of particles for which 50% by weight of the particles have a smaller diameter and 50% by weight have a greater diameter.

The compound will be referred to hereinbelow as flame retardant A.

Preparation of Polyamide-Based Flame-Retarded Composition

The flame-retardant product A obtained above is incorporated in a molten polyamide 6.6 or polyamide 6 matrix using a single- or twin-screw extruder with 30% of glass fibre. The blend is generally extruded in the form of laces which are cut in order to produce granules.

These granules are used as starting material for feeding the processes for the manufacture of flame-retarded moulded articles by injection moulding, moulding or extrusion blow-moulding or by any other process for forming articles.

The properties of these compositions are measured from test specimens obtained by injection moulding starting from granules of a polyamide composition.

Preparation of Test Specimens Made of Flame-Retarded Polyamide 6.6

[symbol] Preparation of Granules

A polyamide 6.6 composition comprising 30% of glass fibres is extruded in a Leistritz twin-screw extruder with a throughput of between 6 and 7 kg/hour, a temperature profile of 250° C. on average and a pressure in the venting zone of approximately 400 mbar being applied. The material pressure measured at the die is in the region of 8 bar.

The flame retardant A and a stabilizing agent are added using metering devices, so as to obtain a level of flame-retardant A in the polymer of 13 or 16% by weight with respect to the final composition. The laces obtained are cut into granules.

[symbol] Preparation of the Test Specimens

The test specimens are obtained by injection moulding the granules obtained above under standard conditions on an 85-tonne Billon press with a cycle time of 40 seconds, a mould temperature of 80° C. and a temperature profile applied to the barrel of 250° C. The test specimens obtained are of standardized shape for carrying out the UL 94 test for determining flame-retardant properties. Test specimens with a thickness of 0.8 mm were produced.

Determination of the Behaviour Towards Fire of the Polyamide Test Specimens

The behaviour towards fire of the samples obtained above is determined according to the UL 94 test published by the Underwriters Laboratories and described in Standard ISO 1210:992 (F). This test is carried out with test specimens with a thickness of 0.8 mm.

The results obtained for the above test specimens are collated in Table II below. Before carrying out the UL 94 test, the test specimens are conditioned by being maintained for 48 hours at 23° C. in an atmosphere exhibiting a relative humidity of 50%.

Furthermore, the GWFT was determined according to the standardized method. The ability to extinguish a flame caused by the application of a glow wire (GWFT) according to Standard IEC 60695-2-12 to test specimens with a thickness of 1.0 mm and a surface area of 80×80 mm at a temperature of 960° C. is measured. The composition is recorded as successfully passing the test when there is ignition during the application of the glow wire but self-extinction within 30 seconds after removal of the said glow wire. The composition is recorded as failing the test when there is ignition during the application of the glow wire and no self-extinction within 30 seconds after removal of the said glow wire. The test is successfully passed when three different test specimens successively confirm the same temperature.

The various characteristics and properties of the compositions obtained are shown in Table II below.

| | 6 | 7 | |
|---|---|---|---|
| | Composition A | Composition B | 8 |
| | PA 6.6 + 30% | PA 6.6 + 30% | Composition C |
| | GF + 13% flame | GF + 16% flame | PA 6.6 + 30% GF + |
| | retardant A + 5% | retardant A + 3% | 13% |
| | melem | melem | flame retardant A |
| UL 94 | V0 | V0 | V1 |
| GWFT | 960° C. | 960° C. | 900° C. |
| Colouring | Light brown | Light brown | Black |

These tests demonstrate the stabilizing effect of the melem and the improvement in the flame-retardant properties.

1-18. (canceled)

19. A flame-retardant system for polymers, comprising a phosphorus-based compound being esters and salts of phosphoric, phosphinic and phosphonic acids and at least one stabilizing compound which is a scavenger of acid functional group and melamine condensation products or derivatives, with a ratio by weight of the stabilizing compound to the phosphorus-comprising compound from 30% to 80%.

20. The flame-retardant system defined by claim 19, wherein the phosphorus-comprising compound is bis[(5-ethyl-2-methyl-2-oxide-1,3,2-dioxaphosphorinan-5-yl)methyl] ester of methylphosphonic acid, alone or as a mixture with the methyl and (5-ethyl-2-methyl-2-oxide-1,3,2,-dioxaphosphorinan-5-yl)methyl ester of methylphosphonic acid, resorcinol bis(diphenyl phosphate), bisphenol A bis(diphenyl phosphate), polyphosphate esters, diethylphosphinic acid, ethylmethylphosphinic acid, methyl(n-propyl)phosphinic acid, or their mixtures, esters and salts.

21. The flame-retardant system defined by claim 20, wherein the stabilizing compound is an alkali metal carbonate, alkaline earth metal carbonate, hydrotalcite or aluminosilicate.

22. The flame-retardant system defined by claim 19, wherein the stabilizing compound is a melamine condensation product.

23. The flame-retardant system defined by claim 22, wherein the melamine condensation product is melem, melam, melon, melamine cyanurate, phosphate or polyphosphate.

24. The flame-retardant system defined by claim 19, wherein the phosphorus-comprising compound is impregnated on a porous solid support.

25. The flame-retardant system defined by claim 24, wherein the porous solid support is silica, alumina, silica/alumina, sodium silicoaluminate, calcium silicate, magnesium silicate, zirconia, magnesium oxide, calcium oxide, cerium oxide or titanium oxide.

26. The flame-retardant system defined by claim 25, wherein the porous solid support is a silica.

27. A flame-retarded polymer-based composition, comprising a flame-retardant system comprising a phosphorus-based compound which is an ester or salt of phosphonic, phosphinic and phosphoric acids and at least one stabilizing compound which is a scavenger of acid functional group and melamine condensation derivatives, with a ratio by weight of the stabilizing compound to the phosphorus-comprising compound being from 30% to 80%.

28. The composition defined by claim 27, wherein the phosphorus-comprising compound has a concentration by weight, expressed as weight of phosphorus, in the composition, of between 5% and 15% with respect to the total weight of the composition.

29. The composition defined by claim 27, wherein the polymer is a thermosetting polymers, thermoplastic polymer or elastomer.

30. The composition defined by claim 29, wherein the thermoplastic polymer is a polyolefin, polyamide, polyester, polycarbonate, styrene polymer, polyurethane, or polyepoxide.

31. The composition defined by claim 30, wherein the thermoplastic polymer is polyamide 6/11, 4/6, 66/6, 6/66, 11, 12, 4, 6, 6.6, 6;9, 6;19, 6.12, 6.18, 6.36; or a branched polyamide.

32. The composition defined by claim 30, wherein the thermoplastic polymer is poly(ethylene terephthalate), poly(propylene terephthalate), poly(butylene terephthalate), or poly(1,4-dimethylcyclohexane terephthalate.

33. The composition defined by claim 27, further comprising bulking fillers, reinforcing fillers, additives for heat or light stabilization, moulding aids or lubricants.

34. The composition defined by claim 27, wherein the phosphorus-comprising compound is impregnated on a porous solid support.

35. The composition defined by claim 34, wherein the porous solid support is silica, alumina, silica/alumina, sodium silicoaluminate, calcium silicate, magnesium silicate, zirconia, magnesium oxide, calcium oxide, cerium oxide or titanium oxide.

36. The composition defined by claim 35, wherein the porous solid support is a silica.
